(19) United States
(12) Patent Application Publication
(10) Pub. No.: US 2009/0252146 A1
(43) Pub. Date: Oct. 8, 2009

(54) CONTINUOUS NETWORK CODING IN WIRELESS RELAY NETWORKS

(75) Inventors: Chong Luo, Beijing (CN); Wei Pu, Anhui (CN); Feng Wu, Beijing (CN); Shipeng Li, Palo Alto, CA (US); Chang Wen Chen, East Amherst, NY (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/061,661

(22) Filed: Apr. 3, 2008

(51) Int. Cl. H04L 12/28

(52) U.S. Cl. 370/351

(57) ABSTRACT

Described is continuous network coding, in which a relay sends probability data comprising a continuous number for use as parity data. The node receives streams of bits sent from sources towards a destination, and computes the probability data based on current noise data and/or fading data. A selected set of the bits (all or some subset thereof) are combined, e.g., XOR-ed or concatenated, and send to the destination. Phase modulation is performed to convey probability information based on the probability data. The destination demodulates the signal to obtain the probability information, and combines the probability information with the data directly received from sources to perform joint decoding. The number of bits in the set of selected bits may be adaptively chosen based on current channel conditions, e.g., increased when the channel conditions from the sources directly to a destination are poor relative to the channel conditions via the relay.

### BACKGROUND

Network coding generally refers to having interior network nodes perform some coding operations, rather than simply using those nodes to route data to a destination. Network coding has been applied to wireless networks to increase network capacity. For example, by applying network coding and utilizing broadcast capability at a wireless relay node, the overall time it takes to exchange a message through a common relay can be reduced.

Previous wireless network coding has been directed towards utilizing the broadcast nature of the wireless networks. However, existing network coding schemes assume error-free decoding at the relay nodes, which is virtually impossible in current wireless environments, which are error prone, e.g., due to channel noise and fading effects. As a result, relay nodes may introduce additional errors in the decode-recode process, and these errors may be propagated to the destination node.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an intermediate network node, for example a relay, sends probability data comprising a continuous number in a continuous network coding scheme (for example instead of discretely decided ones or zeros). The node receives signals corresponding to streams of bits sent from sources towards a destination, and computes the probability data based on current noise data and/or fading data. A selected set of the bits (all or some subset thereof) are combined, e.g., XOR-ed or concatenated, and send to the destination in a modulated manner (e.g., phase modulated) to include probability information based on the probability data.

The destination demodulates the signal to obtain the probability information, and uses the probability information as parity data, e.g., combined with the data the destination received directly from the source to decode the original data streams.

In one example aspect, the number of bits in the set of selected bits is adaptively chosen based on current channel conditions. For example, the number is increased when the channel conditions from the sources directly to a destination are poor relative to the channel conditions from the sources indirectly to the destination via the relay.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example network topology including a continuous network coding relay.

FIG. 2 is a block diagram representing example details of components in an example continuous network coding framework in a network topology.

FIG. 3 is a representation of a constellation representative of continuous modulation used continuous network coding.

FIG. 4 is a flow diagram showing example steps taken by a continuous network coding-capable relay.

FIG. 5 is a flow diagram showing example steps taken by a destination that receives signals from a continuous network coding-capable relay.

### DETAILED DESCRIPTION

Various aspects of the technology described herein are generally directed towards extending traditional network coding in a lossless network, by computing and forwarding a continuous number corresponding to a probability value for received bits rather than deciding a discrete zero or one value for each bit. Note that the concept of “continuous” numbers allows for rounding, e.g., to some number of decimal points, and in any event allows for more than simply one of two discrete values for each bit.

In general and as described below, the continuous number computed for a given bit corresponds a probability value (e.g., a posterior probability based on noise and/or fading effects) that the bit was intended to be a zero or one when the bit is received at an intermediary (e.g., relay) node. In one example, this probability value is used as parity data and forwarded to the destination in some combination with probability value-based parity data from other bits, including bits from another source. For example, selected bits from each of two sources may be concatenated and sent in a stream to the destination, with modulation (e.g., phase modulation) used to indicate the probability value of each bit. In another example, the bits of separate streams (e.g., similarly positioned bits) may be combined (e.g., XOR-ed) with a resultant probability value for each combination sent to the destination. The destination can then process the parity data and use it in decoding the original streams, e.g., in a low-density parity-check (LDPC) decoder. Significant improvements over traditional network coding have been achieved with such exemplified continuous network coding approaches.

While various aspects and examples are directed towards a framework that leverages distributed LDPC coding, it is understood that this is only one example, and that other coding schemes may be used with continuous network coding values. Further, the examples are directed towards a network topology of nodes comprising two sources, one relay and one destination, but it is generally understood that continuous network coding applies to any network topology having a practical number of such nodes. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, and data coding in general.

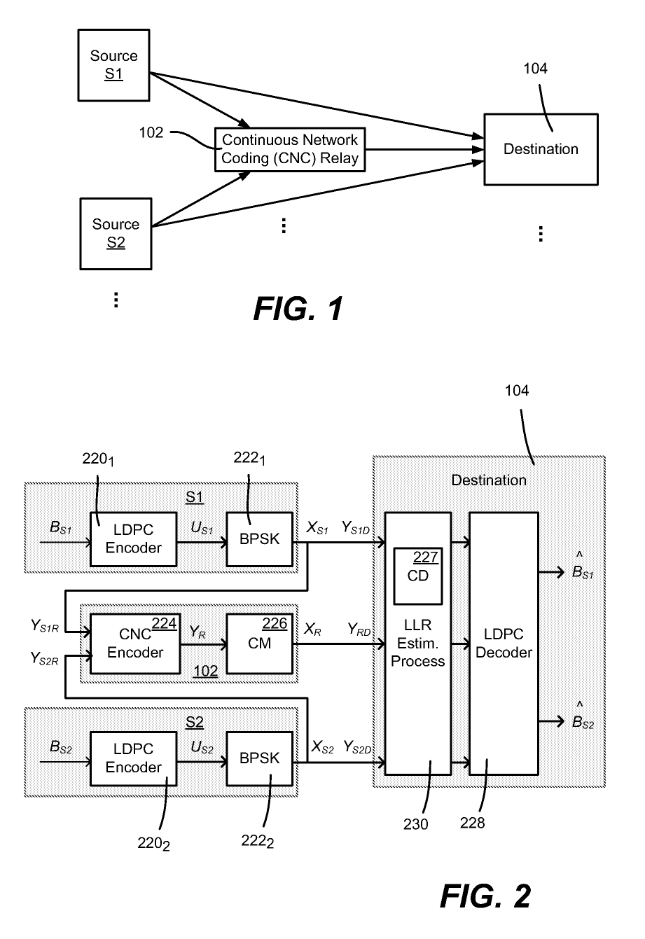

Turning to FIG. 1, there is shown a general representation of a network configured for various aspects of continuous network coding. In general, FIG. 1 shows a four-node network topology comprising a two-hop wireless relay network including sources S1 and S2, a relay 102, and a destination 104. In one example, the various terminals employ half-duplex transmission, with a channel divided into orthogonal sub-channels. In this example, each node may be considered as transmitting in different time slots, that is, time-division medium access (TDMA) is one transmission model. As can be readily understood and as represented by the dots extending the components, any practical number of sources, relays and/or destinations may be present in a given configuration and benefit from continuous network coding.

In one example implementation, each source S1 or S2 independently generates information bits, and protects them with low-density parity-check (LDPC) codes. The bits are then transmitted in time-separated streams destined for the destination 104, but also received at the relay 102.

For purposes of clarity herein, a symbol notation is used herein that maps zero (0) bit values to plus one (+1), and one (1) bit values to minus one (−1), that is, from {0, 1} to {+1, −1} whereby the XOR operation in LDPC encoding on {0, 1} corresponds to multiplication on {+1, −1}. With this mapping, the set U of coded information bits for some number of bits i may be represented by:

U={u₁,u₂, . . . uₙ},uᵢε{±1}

In one example, for transmission from the source, these bits are modulated with binary phase-shift keying (BPSK) modulation.

As represented in FIG. 1 by the directional arrows, when a source S1 or S2 broadcasts data, the relay 102 and the destination 104 are able to receive the data. One primary functionality of the relay is to provide space diversity and code diversity to combat channel fading.

The channels in FIG. 1 are assumed to be quasi-static Rayleigh fading channels with additive noise, whereby the channel may be modeled as:

Yₘ=hₘ\sqrt{E_{s,m}}Xₘ+wₘ (1)

where Yₘ are received samples after matched filter, E_{s,m} is the symbol energy, hₘ is the fading gain, wₘ is the channel noise, and m is the block index. The fading gain hₘ is normalized with E[hₘ²]=1, whereby the power spectrum density considers the effect of path-loss.

The fading gain hₘ is modeled as a Rayleigh distributed variable, which remains constant during one codeword length, and changes independently from one codeword to another; such a channel is also referred to as quasi-static channel. The channel noise wₘ is additive Gaussian white noise (AGWN), with zero mean and one side power density spectrum N₀.

With respect to network coding, in one example implementation, distributed LDPC code is used as the joint channel-network code. However, unlike conventional network coding such as based upon decode-recode-forward, as described herein the relay performs continuous network coding. More particularly, instead of making a discrete one or zero decision on each received bit, and then XOR-ing that decided bit value with a counterpart value of another stream, the continuous network coding relay computes probability (e.g., posterior probability) data for each bit or some other selected set of bits based on the noise/fading conditions. Those probability values are then sent to the destination as parity data in a stream of selected bits.

In BPSK modulation, which is what is used at the sources, the above described sign-magnitude representation may be mapped to a posterior probability based representation:

zᵢ:=2Pr{uᵢ=1|y_{I}}−[−1,1] (2)

Assuming that the fading coefficient is correctly estimated by the receiver, then the posterior probability is:

$$\begin{matrix}Pr \{ {u}_{i} = 1 \vert {y}_{i} \} = \frac{{e}^{- \frac{{( {y}_{i} - \sqrt{{E}_{s}} )}^{2}}{2 {σ}^{2}}}}{{e}^{- \frac{{( {y}_{i} - \sqrt{{E}_{s}} )}^{2}}{2 {σ}^{2}}} + {e}^{- \frac{{( {y}_{i} + \sqrt{{E}_{s}} )}^{2}}{2 {σ}^{2}}}} \\ = \frac{{e}^{\frac{\sqrt{{E}_{s}}}{{σ}^{2}} {y}_{i}}}{{e}^{\frac{\sqrt{{E}_{s}}}{{σ}^{2}} {y}_{i}} + {e}^{- \frac{\sqrt{{E}_{s}}}{{σ}^{2}} {y}_{i}}}\end{matrix} \qquad ( 3 )$$

Then, zᵢ may be expressed as:

$${z}_{i} = \frac{{e}^{\frac{\sqrt{{E}_{s}}}{{σ}^{2}} {y}_{i}} - {e}^{- \frac{\sqrt{{E}_{s}}}{{σ}^{2}} {y}_{i}}}{{e}^{\frac{\sqrt{{E}_{s}}}{{σ}^{2}} {y}_{i}} + {e}^{- \frac{\sqrt{{E}_{s}}}{{σ}^{2}} {y}_{i}}} = tanh ( \frac{\sqrt{{E}_{s}}}{{σ}^{2}} y ) \qquad ( 4 )$$

Thus, when the received symbol zᵢ is close to one (1), the corresponding binary information bit uᵢ has a high probability to be one (1); when zᵢ is close to −1, uᵢ is likely to be minus one (−1). Therefore, in wireless networks, zᵢ is the counterpart of ±1 in traditional network coding.

However, unlike the decode-recode-forward scheme, which solves for the original bits with an LDPC decoder and thus introduces and propagates new errors if the channel condition is not perfect, continuous network coding retains the information carried by yᵢ, and carries the information on to the destination. Because the destination receives another coded message from an independent channel, it is more likely that the destination will more accurately recover the information bits.

In one aspect, continuous network coding mixes bit sequences without knowing the exact value of each bit, by defining XOR over posterior probability. To this end, for a sequence of k symbols zᵢ, i=1, 2 . . . k, which are calculated from received symbols yᵢ using equation (4), let u=u₁⊕u₂⊕ . . . uₖ. Then the posterior probability Pr{u=1|y₁, . . . yₖ} is calculated with the following equation:

$$Pr \{ u = 1 \vert {y}_{1} , … , {y}_{k} \} = \frac{1 + {\prod }_{i = 1}^{k} {z}_{i}}{2} \qquad ( 5 )$$

In one example, a bit's probability value may be combined (e.g., XOR-ed) with a counterpart bit's probability value of another stream, and the relay then transmits parity information corresponding to the combined probability values. Such an XOR combination may be defined over posterior probability as:

z=⊕ᵢ₌ₗ^{k}zᵢ:=2Pr{u=1|y₁, . . . yₖ}−1 (6)

where

$$z = {\prod }_{i = 1}^{k} {z}_{i} \qquad ( 7 )$$

By way of a numerical example, consider a received bit that based on current noise and/or fading effects has an eighty percent probability of being a one, and thus a twenty percent probability of being a zero. When combined with a another stream's counterpart bit having a ninety percent probability of being zero and thus a ten percent probability of being one, the XOR operation results in a combined value of (0.9*0.8)+(0.1*0.2), or 0.74. Note that when the channel approaches a lossless state, i.e., uᵢ approaches yᵢ, then:

$$\begin{matrix}{z}_{i} = {lim}_{σ \to {0}^{+}} tanh ( \frac{\sqrt{{E}_{s}}}{{σ}^{2}} {y}_{i} ) \\ = {lim}_{σ \to {0}^{+}} tanh ( \frac{\sqrt{{E}_{s}}}{{σ}^{2}} {u}_{i} ) \\ = {u}_{i} z = {\prod }_{i = 1}^{k} {z}_{i} = {\prod }_{i = 1}^{k} {u}_{i} = {⊕}_{i = 1}^{k} {x}_{i}\end{matrix} \qquad ( 8 )$$

In one alternative example, any number of bits may be used to generate parity bits. For example, a selected set of bits from the received streams may be combined by concatenation (or an XOR operation), with parity bits generated from that stream. Note that this type of combination allows for combining unequal length codewords from multiple sources. For example, not all bits need be used, nor do those selected need to be contiguous, e.g., any set of the bits from the streams may be selected, such as randomly, in a pattern and so forth. Compared to a bit-by-bit XOR operation, this scheme allows an adaptive framework, as described below.

FIG. 2 is a block diagram representation of a continuous network coding framework arranged as in FIG. 1. The original information bits from the sources S1 and S2 are represented by B_{S1} and B_{S2} respectively. The corresponding coded bits after LDPC encoding by the LDPC encoders 220₁ and 220₂ are represented by U_{S1} and U_{S2}, respectively. The modulated signals (e.g., X_{S1} and later X_{S2}) are sent out and are received by the relay 102 and the destination 104. The signals received at the relay 102 and the destination 104 from the source S1 are denoted by Y_{S1R} and Y_{S1D}, respectively; those from the source S2 are denoted by Y_{S2R} and Y_{S2D}, respectively. Note that each signal as received was subject to possibly different noise and fading effects during its transmission.

In this example, the relay 102 receives signals from the sources S1 and S2 and generates a message Y_{R} using a continuous network coding (CNC) encoder 224. In one example, the CNC encoder 224 may be generally similar to a standard LDPC encoder, except that an XOR operation is performed as above on probability values instead of on discrete ones or zeroes, using any appropriate number of bits. In one alternative example, the selected bits may be concatenated, with parity bits generated from that stream.

As described above, the elements of Y_{R} are continuous values ranging from −1 to 1, and thus cannot be modulated by BPSK or other binary-based modulation. Instead, in one example implementation, analog phase modulation is used to transmit these continuous values, via a continuous (phase) modulation (CM) component 226. A continuous (e.g., phase) demodulation (CD) component 227 at the destination demodulates the continuous values. Note that other types of modulation are feasible, such as amplitude or frequency modulation.

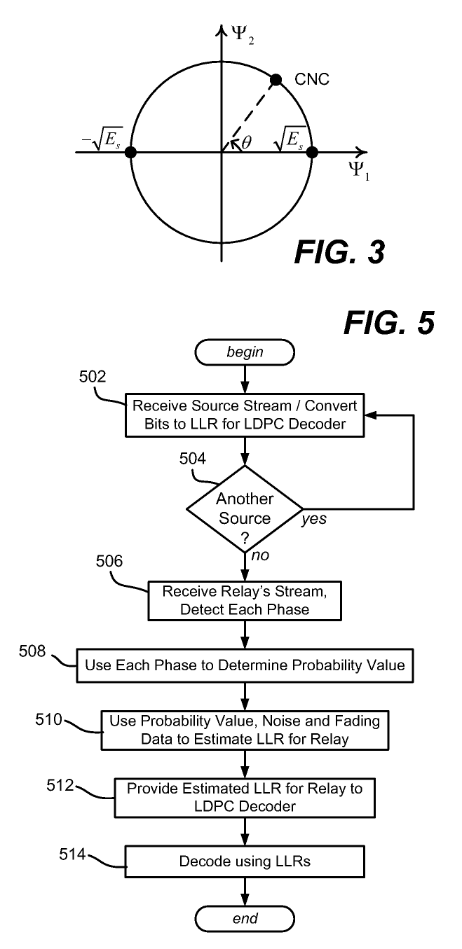

FIG. 3 is a representation of the constellation of continuous phase modulation. In FIG. 3, Ψ1, Ψ2 are the two orthogonal base signals in QPSK (Quadrature Phase Shift Keying). The phase θ is determined by the following equation, in which y is an element of Y_{R}:

$$θ = \frac{1 - y}{2} π \qquad ( 9 )$$

As represented in FIG. 2, the destination 104 receives three signals, namely Y_{S1D}, Y_{S2D} and Y_{R}. The destination 104 passes these signals to its LDPC decoder 228 in order to solve the original codeword of the two sources. The exemplified framework uses an LDPC decoder 228, which needs to know each bit's log posterior ratio (LLR) to start its iterative decoding process; LLR can be expressed as:

$$L L R = log \frac{Pr \{ u = 1 \vert \hat{y} \}}{Pr \{ u = - 1 \vert \hat{y} \}} = log \frac{Pr \{ \hat{y} \vert u = 1 \}}{Pr \{ \hat{y} \vert u = - 1 \}} \qquad ( 10 )$$

Note that the “̂” notation (e.g., ŷ instead of y) and so forth is used to indicate that the received signal is subject to noise and fading effects, and is thus not necessarily the same as what was transmitted.

In FIG. 2, an LLR estimation process 230 is shown as performing the computations. It is straightforward to obtain the LLR for the bits in the Y_{S1D} and Y_{S2D} streams, as these are BPSK modulated. However, for the bits in the Y_{R} stream, the calculation is more difficult. In one example, a two-step process may be used for the calculation. In a first step, when the estimation process 230 receives the relay's signal, it detects the phase \hat{θ}, and estimates ŷ using:

$$\hat{y} = 1 - \frac{2 \hat{θ}}{π} \qquad ( 11 )$$

In a second step, using known techniques, ŷ can be modeled as:

ŷ=hx+w_{rd} (12)

where h is a model parameter related to fading.

If the parameter h and noise variance are well estimated, equation (10) can be reduced to the expression:

$$L L R = \frac{2 h \hat{y}}{{σ}_{r d}^{2}} \qquad ( 13 )$$

Once LLR is thus estimated by the process 230, the LDPC decoder 228 in the destination 104 runs the standard LDPC decoding process, and outputs B_{S1} and B_{S2}.

As described above, not all bits need to be used in generating the parity data. This provides an adaptive framework for continuous network coding. For example, when the channel condition from the source directly to the destination is poor relative to the channel condition from the source indirectly to the destination via the relay, more parity bits may be allocated to the relay improve the likelihood of single-hop transmission success. Conversely, when the direct channel condition is good, having too many parity bits does not improve single-hop transmission quality and lowers performance. Thus, the number of parity bits that are used may be adaptively varied based on current channel conditions to exploit the space diversity as appropriate.

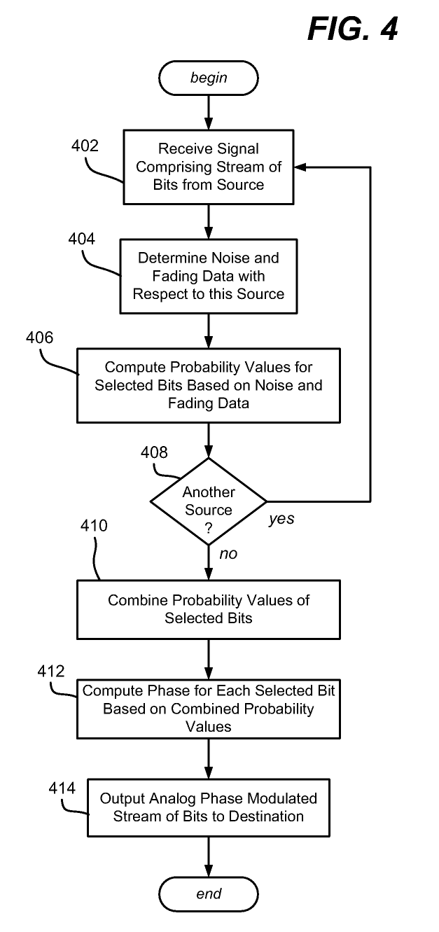

By way of summary, FIGS. 4 and 5 are flow diagrams comprising example operations taken at the relay and destination, respectively. Note that while the exemplified steps are shown as taking place serially, it is understood that certain ones may operate in parallel, e.g., the relay and/or destination may begin processing a bit with respect to continuous encoding and decoding as other bits are being received.

At step 402 of FIG. 4, the relay begins receiving a signal from a source, at step 404 determines the noise and fading as described above, and at step 406 computes the probability value for a selected set of the bits, e.g., all or less than all. Step 408 repeats for the other source or sources which transmit at different times.

Step 410 represents mathematically combining the probability values of the selected bits in some way, e.g., via XOR-ing or concatenating. As each selected or resultant bit is ready, step 412 computes the phase (or other modulation variable). Step 414 outputs the phase modulated stream of bits to the destination. Note that as described above, steps 410, 412 and 414 can operate to an extent in parallel, e.g., there is no reason to wait for the entire stream to be ready before transmission may begin.

FIG. 5 represents the example operations taken at the destination, in which step 502 represents receiving a stream from one source and converting the bits as appropriate (e.g., LLR as described above) for the decoder. Step 504 represents repeating until each of the source streams have been received.

Step 506 represents receiving the relay's stream and detecting the phases for each bit that was selected and processed at the relay. As described above, each phase corresponds to probability data, which is used (step 510) to estimate the relay's input (e.g., LLR) to the decoder at step 512. Step 514 represents the decoder using the three LLRs to decode bit streams.

As can be seen, there is provided a continuous network coding framework for use in wireless relay networks. By computing and relaying soft probability information for each selected bit, the relay node avoids possible error propagation. This property results in a significant performance gain over traditional network coding for wireless relay networks. Further, the technology described herein facilitates adaptive continuous network coding, which allows nodes to adapt to channel conditions.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a network environment, a method at a node, comprising:
receiving signals corresponding to streams of bits sent from a plurality of sources towards a destination;
computing probability data comprising a continuous number corresponding to how likely each bit of a set of selected bits from the streams corresponds to a zero or one value;
combining the set of selected bits into a stream such that a plurality of probability values correspond to at least some of the bits of the stream; and
transmitting data to the destination from which the probability values may be determined for use in signal decoding.

2. The method of claim 1 wherein computing the probability data comprises using noise and fading data.

3. The method of claim 1 wherein transmitting the data comprises modulating a signal to represent each of the probability values.

4. The method of claim 3 further comprising, demodulating the signal to determine each of the probability values.

5. The method of claim 1 further comprising computing a computed phase representative of the each probability value, and performing phase modulation corresponding to each computed phase.

6. The method of claim 1 wherein combining the set of selected bits into a stream comprises mathematically combining selected bits from a plurality of streams.

7. The method of claim 1 wherein combining the set of selected bits into a stream comprises concatenating selected bits from a plurality of streams.

8. The method of claim 1 further comprising, adapting a number of bits chosen for the set of selected bits based on channel conditions.

9. In a network computing environment in which source nodes transmit data signals towards a destination, a system comprising, an intermediate node, including a continuous network coding encoder that computes probability information as to the likelihood that a bit value transmitted by a source was correctly received, and a continuous modulation component that provides a modulated signal to the destination indicative of the probability information.

10. The system of claim 9 wherein the continuous modulation component performs phase modulation based on a phase representative of the probability information.

11. The system of claim 9 wherein the destination comprises a continuous demodulation component that determines the probability information based on the modulated signal.

12. The system of claim 11 wherein the destination includes an LLR estimation process that uses the probability information to provide an LLR to an LDPC decoder.

13. One or more computer-readable media having computer-executable instructions, which when executed perform steps, comprising:
receiving a plurality of signals corresponding to streams of bits, each bit having a bit value;
determining, for each bit of a selected set of bits in each stream, probability data indicative of a likelihood that the bit value as received is the same as was transmitted; and
sending probability information based upon the probability data, including performing signal modulation to represent the probability information.

14. The one or more computer-readable media of claim 13 having further computer-executable instructions comprising, combining the probability data into the probability information.

15. The one or more computer-readable media of claim 14 wherein combining the probability data into the probability information comprises mathematically combining bits from each stream.

16. The one or more computer-readable media of claim wherein combining the probability data into the probability information comprises concatenating some bits from each stream.

17. The one or more computer-readable media of claim 13 wherein determining the probability data comprises using noise data or fading data, or both noise data and fading data.

18. The one or more computer-readable media of claim 13 wherein performing signal modulation performing phase modulation.

19. The one or more computer-readable media of claim 13 having further computer-executable instructions comprising, adapting a number of bits chosen for the set of selected bits based on channel conditions.

20. The one or more computer-readable media of claim 19 wherein adapting the number of bits comprises increasing the number when the channel conditions from a source directly to a destination are poor relative to the channel conditions from the source indirectly to the destination via a relay.
